(19) United States
(12) Patent Application Publication
(10) Pub. No.: US 2016/0359572 A1
(43) Pub. Date: Dec. 8, 2016

(54) ENABLING HIDDEN NODE PROTECTION PROCEDURE

(71) Applicant: QUALCOMM Incorporated, San Diego, CA (US)

(72) Inventors: Yan ZHOU, San Diego, CA (US); Gwendolyn Denise BARRIAC, Encinitas, CA (US); Simone MERLIN, Solana Beach, CA (US); George CHERIAN, San Diego, CA (US)

(21) Appl. No.: 14/866,753

(22) Filed: Sep. 25, 2015

Related U.S. Application Data
(60) Provisional application No. 62/127,791, filed on Mar. 3, 2015.

(51) Int. Cl. H04B 15/00; H04W 74/08

(52) U.S. Cl. CPC H04B 15/00; H04W 74/0816; H04B 17/345

(57) ABSTRACT

In an aspect of the disclosure, a method, a computer-readable medium, and an apparatus are provided. The apparatus may be a first device. The first device determines a transmission link condition for transmitting at least one frame to a second device, the transmission link condition affecting interference received by the second device from a hidden node when the second device is receiving the at least one frame. The first device also determines whether the transmission link condition satisfies a predetermined criterion. The first device further enables a hidden node protection procedure when the transmission link condition satisfy the predetermined criterion, the hidden node protection procedure reserving a medium used for transmitting the at least one frame to protect reception at the second device from the interference caused by the hidden node. The first device yet further transmits the at least one frame to the second device.

### CROSS-REFERENCE TO RELATED APPLICATION(S)

This application claims the benefit of U.S. Provisional Application Ser. No. 62/127,791, entitled “ENABLING HIDDEN NODE PROTECTION PROCEDURE” and filed on Mar. 3, 2015, which is expressly incorporated by reference herein in its entirety.

### BACKGROUND

Field

The present disclosure relates generally to communication systems, and more particularly, to techniques for enabling a hidden node protection procedure on wireless devices in a wireless network.

Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infrared, optical, etc. frequency bands. Wireless networks advantageously facilitate user mobility and rapid field deployment when compared to fixed wired networks.

Wireless communication devices may enable a hidden node protection procedure to protect communications from hidden node interference. There is a need for an improved enablement mechanism in order to more effectively use the hidden node protection procedure.

### SUMMARY

The systems, methods, computer program products, and devices of the invention each have several aspects, no single one of which is solely responsible for the invention's desirable attributes. Without limiting the scope of this invention as expressed by the claims which follow, some features will now be discussed briefly. After considering this discussion, and particularly after reading the section entitled “Detailed Description,” one will understand how the features of this invention provide advantages for devices in a wireless network.

In an aspect of the disclosure, a method, a computer-readable medium, and an apparatus are provided. The apparatus may be an access point (AP) or a station (STA). The apparatus may be a first device. The first device determines a transmission link condition for transmitting at least one frame to a second device, the transmission link condition affecting interference received by the second device from a hidden node when the second device is receiving the at least one frame. The first device also determines whether the transmission link condition satisfies a predetermined criterion. The first device further enables a hidden node protection procedure when the transmission link condition satisfy the predetermined criterion, the hidden node protection procedure reserving a medium used for transmitting the at least one frame to protect reception at the second device from the interference caused by the hidden node. The first device yet further transmits the at least one frame to the second device.

### BRIEF DESCRIPTION OF THE DRAWINGS

FIG. 1 shows an example wireless communication system in which aspects of the present disclosure may be employed.

FIG. 2 is a diagram illustrating wireless devices in a wireless network.

FIG. 3 is a diagram illustrating a format of an exemplary IE used for carrying enablement configurations.

FIG. 4 is a diagram illustrating a format of an exemplary IE used for carrying frame exchange types.

FIG. 5 is a diagram illustrating a format of an exemplary IE used for carrying frame exchange types.

FIG. 6 is a diagram illustrating a format of an exemplary IE used for carrying a time indicator.

FIG. 7 is a flow chart of an exemplary method for selectively enabling a hidden node protection procedure.

FIG. 8 is a flow chart of an exemplary method for determining whether to proceed with an enablement determination based on a device indicator.

FIG. 9 is a flow chart of an exemplary method for determining whether to proceed with an enablement determination based on a time indicator.

FIG. 10 is a flow chart of an exemplary method for determining whether to proceed with an enablement determination based on a mode indicator.

FIG. 11 is a flow chart of an exemplary method for determining whether to proceed with an enablement determination based on a frame exchange type indicator.

FIG. 12 shows an example functional block diagram of a wireless device that may be employed within the wireless communication system of FIG. 1 or the wireless network of FIG. 2.

FIG. 13 is a conceptual data flow diagram illustrating the data flow between different components/means in an exemplary apparatus.

### DETAILED DESCRIPTION

Various aspects of the novel systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as a wireless protocol.

In some aspects, wireless signals may be transmitted according to an Institute of Electrical and Electronics Engineers (IEEE) 802.11 protocol using orthogonal frequency-division multiplexing (OFDM), direct-sequence spread spectrum (DSSS) communications, a combination of OFDM and DSSS communications, or other schemes. Implementations of the IEEE 802.11 protocol may be used for sensors, metering, and smart grid networks. Advantageously, aspects of certain devices implementing the IEEE 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a WiFi (e.g., IEEE 802.11 protocol) compliant wireless link to obtain general connectivity to the Internet or to other wide area networks. In some implementations a STA may also be used as an AP.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations an access terminal may comprise a cellular telephone, a cordless telephone, a Session Initiation Protocol (SIP) phone, a wireless local loop (WLL) station, a personal digital assistant (PDA), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

The term “associate,” or “association,” or any variant thereof should be given the broadest meaning possible within the context of the present disclosure. By way of example, when a first apparatus associates with a second apparatus, it should be understood that the two apparatus may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the IEEE 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

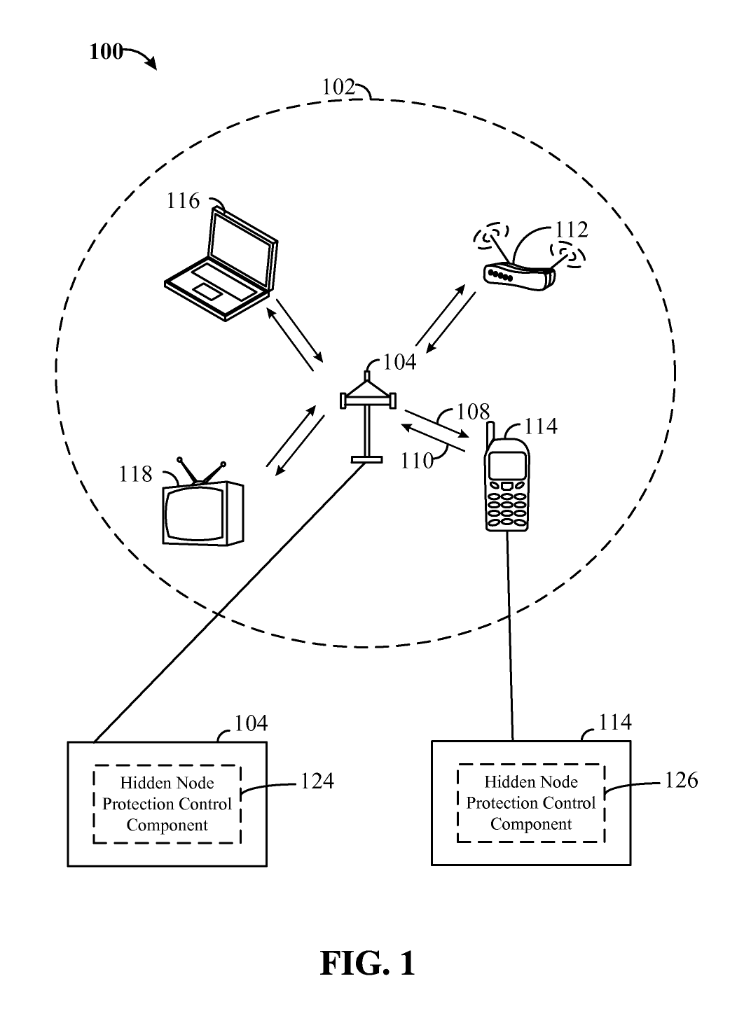

FIG. 1 shows an example wireless communication system 100 in which aspects of the present disclosure may be employed. The wireless communication system 100 may operate pursuant to a wireless standard, for example the IEEE 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may improve suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the AP 104 may include one or more components for performing various functions. For example, the AP 104 may include a hidden node protection control component 124. The hidden node protection control component 124 may control a process of determining a transmission link condition for transmitting at least one frame to a second device, the transmission link condition affecting interference received by the second device from a hidden node when the second device is receiving the at least one frame. The hidden node protection control component 124 may control a process of determining whether the transmission link condition satisfies a predetermined criterion. The hidden node protection control component 124 may control a process of enabling a hidden node protection procedure when the transmission link condition satisfy the predetermined criterion, the hidden node protection procedure reserving a medium used for transmitting the at least one frame to protect reception at the second device from the interference caused by the hidden node. The hidden node protection control component 124 may control a process of transmitting the at least one frame to the second device.

In another aspect, the STA 114 may include one or more components for performing various functions. For example, the STA 114 may include a hidden node protection control component 126. The hidden node protection control component 126 may control a process of determining a transmission link condition for transmitting at least one frame to a second device, the transmission link condition affecting interference received by the second device from a hidden node when the second device is receiving the at least one frame. The hidden node protection control component 126 may control a process of determining whether the transmission link condition satisfies a predetermined criterion. The hidden node protection control component 126 may control a process of enabling a hidden node protection procedure when the transmission link condition satisfy the predetermined criterion, the hidden node protection procedure reserving a medium used for transmitting the at least one frame to protect reception at the second device from the interference caused by the hidden node. The hidden node protection control component 126 may control a process of transmitting the at least one frame to the second device.

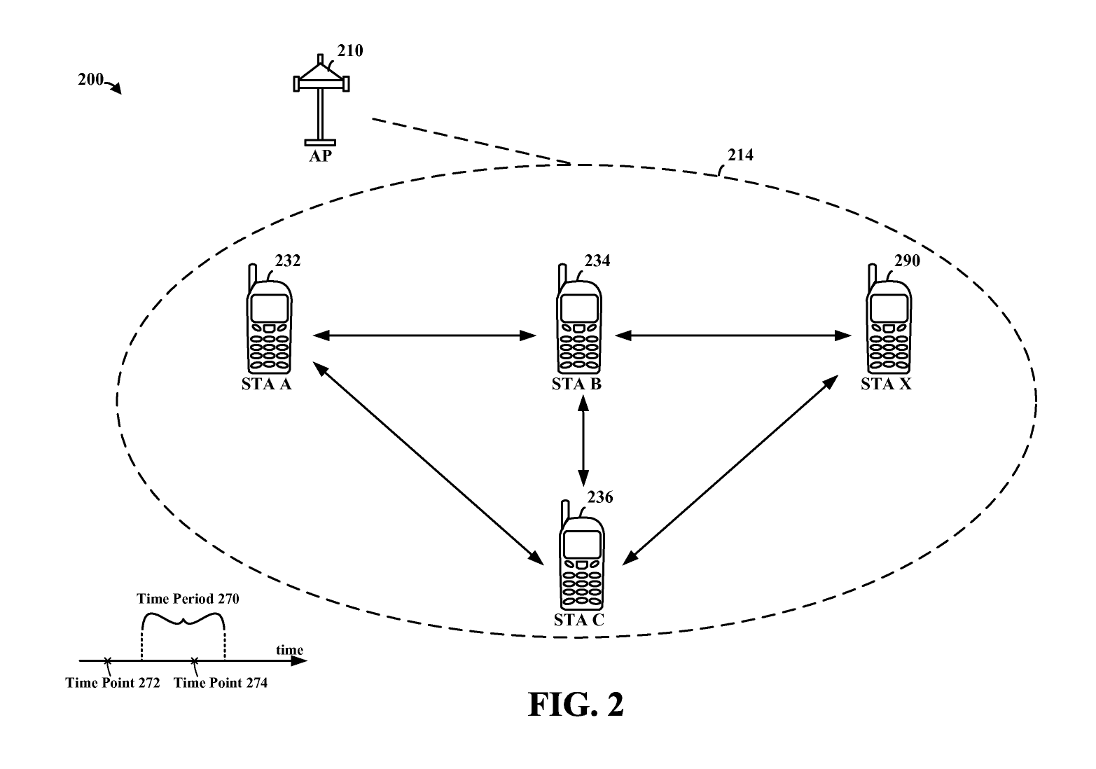

FIG. 2 is a diagram 200 illustrating wireless devices in a wireless network (e.g., a WiFi network). Particularly, in various examples, a wireless network, as described infra, may include two or more of an AP 210, a STA A 232, a STA B 234, a STA C 236, and a STA X 290. In certain configurations, one or more of the STA A 232, the STA B 234, the STA C 236, and the STA X 290 may be associated with the AP 210. One or more of the STA A 232, the STA B 234, the STA C 236, and the STA X 290 may be in a BSS 214 managed by the AP 210.

In the present disclosure, when a node A (e.g., the STA A 232) exchanges a frame with a node B (e.g., the STA B 234), the node A may transmit a frame to the node B or the node A may receive a frame from the node B. In the present disclosure, the term exchange is used in this manner unless otherwise noted. Further, the present disclosure may use one or more STAs or APs as exemplary wireless devices to illustrate the techniques described infra. Nonetheless, the STAs described infra may be replaced by APs. Similarly, the APs described infra may be replaced by STAs. As such, the techniques described infra apply equally in those configurations.

In the techniques described infra, a wireless device may obtain enablement configurations indicating one or more enabling criteria for enabling a hidden node protection procedure. The wireless device may determine whether to enable the hidden node protection procedure according to whether an enabling metric for initiating exchanging at least one frame with one or more other wireless devices is in a predefined relationship with an enabling criterion. The enabling metric may be a transmission link condition. The transmission link condition may include at least one of (a) a duration required for exchanging the at least one frame, (b) a frame type of the at least one frame, (c) a retry count for transmitting at least one medium access control (MAC) service data unit (MSDU) in the at least one frame, and (d) a relation type of the wireless device with respect to the one or more other wireless devices.

In one example, the STA A 232 may wish to communicate with the STA B 234. Particularly, the STA A 232 may have a data frame to be transmitted to the STA B 234. (In other configurations, one or each of the STA A 232 and the STA B 234 may be replaced by an AP. Particularly, the STA B 234 may be replaced by the AP 210.) The STA A 232 may determine that a transmission time duration T is needed in order to transmit, or allocated for transmitting, the data frame to the STA B 234. The STA A 232 may have a hidden node STA X 290, which is not a hidden node to the STA B 234. The STA A 232 may be configured with a frame exchange duration threshold. If the transmission time duration T is greater than the frame exchange duration threshold, the STA A 232 may employ a hidden node protection procedure to transmit the data frame to the STA B 234. For example, the frame exchange duration threshold may be 0.5 ms, 1 ms, or 1.5 ms. One consideration is that because the STA X 290 is a hidden node to the STA A 232 (i.e., the STA X 290 is not within the transmission range of the STA A 232), the STA X 290 may not detect the data frame transmitted from the STA A 232 and a medium reservation parameter such as a network allocation vector (NAV) associated with the data frame. When the transmission time duration T is long (e.g., greater than the frame exchange duration threshold), it is more likely that the STA X 290 will transmit signals to the STA B 234 during the transmission time duration T, causing interference to the transmission between the STA A 232 and the STA B 234.

In certain configurations, when the transmission time duration T is greater than the frame exchange duration threshold, the STA A 232 may use a hidden node protection procedure such as the RTS/CTS procedure to reserve the medium for the transmission time duration T. Specifically, the STA A 232 may transmit an RTS directed to the STA B 234, the RTS indicating the transmission time duration T (e.g., through NAV). Upon receiving the RTS, the STA B 234 may transmit a corresponding CTS indicating the transmission time duration T and directed to the STA A 232. Because the STA X 290 is not a hidden node to the STA B 234 (i.e., the STA X 290 is within the transmission range of the STA B 234), the STA X 290 also receives the CTS. Accordingly, the STA X 290 observes the RTS/CTS procedure and does not transmit signals in the transmission time duration T. Thus, the data communication between the STA A 232 and the STA B 234 may be protected in the transmission time duration T against the interference caused by the STA X 290.

In certain configurations, when the transmission time duration T is greater than the frame exchange duration threshold, the STA A 232 and the STA B 234 may use another hidden node protection procedure such as a CTS-to-self procedure to reserve the medium for the transmission time duration T. Specifically, the STA A 232 may transmit the data frame directed to the STA B 234, the data frame indicating the transmission time duration T (e.g., through NAV). The wireless devices within the transmission range of the STA A 232 may detect the data frame and therefore will not transmit signals during the transmission time duration T. Upon receiving the data frame, the STA B 234 extracts the transmission time duration T indicated in the data frame. The STA B 234 may be configured with the frame exchange duration threshold. If the STA B 234 determines the transmission time duration T is greater than the frame exchange duration threshold, the STA B 234 may send a CTS directed to itself, the CTS indicating the transmission time duration T. Accordingly, the wireless devices within the transmission range of the STA B 234 (including the STA X 290) may detect the CTS and accordingly will not transmit signals within the transmission time duration T. Alternatively, the STA A 232 may transmit a CTS-to-self before sending the data frame to the STA B 234. The NAV in CTS-to-self may be encoded at the lower rate than the NAV in the data frame. Therefore, the NAV in CTS-to-self may be more reliably decoded by the STA X 290, which may not be able to decode the NAV in the data frame.

In certain configurations, the STA A 232 and the STA B 234 may wish to exchange a sequence of data frames. For example, the STA A 232 may determine that a data frame to be transmitted to the STA B 234 includes a request message that solicits one or more response messages from the STA B 234. The STA A 232 may estimate the transmission time duration T for exchanging the request message and response message. Accordingly, in one technique, when the transmission time duration T is greater than the frame exchange duration threshold, before sending the first data frame of the sequence of data frames that are to be exchanged, the STA A 232 may send an RTS directed to the STA B 234, the RTS indicating the transmission time duration T. Upon receiving the RTS, the STA B 234 may transmit a corresponding CTS indicating the transmission time duration T and directed to the STA A 232. Thus, the data communication between the STA A 232 and the STA B 234 may be protected in the transmission time duration T against the interference caused by the STA X 290.

In another technique, the STA A 232 sends to the STA B 234 the first data frame of the sequence of data frames that are to be exchanged. Upon receiving the first data frame, the STA B 234 may determine that the first data frame indicates, or is part of, the sequence of data frames that are to be exchanged and that the transmission time duration T is required to exchange the sequence of data frames. For example, the STA B 234 may determine that the first data frame contains a request message that solicits one or more response messages from the STA B 234. Accordingly, if the STA B 234 determines the transmission time duration T is greater than the frame exchange duration threshold, the STA B 234 may send a CTS directed to itself, the CTS indicating the transmission time duration T. As such, the wireless devices within the transmission range of the STA B 234 may detect the CTS and accordingly will not transmit signals within the transmission time duration T.

In certain configurations, the STA A 232 may determine that the STA A 232 and a group of wireless devices wish to exchange a sequence of data frames. In this example, the group of wireless devices includes the STA B 234 and the STA C 236. The STA A 232 may determine that a transmission time duration T required to exchange the sequence of data frames is greater than the frame exchange duration threshold. Accordingly, the STA A 232 may transmit an RTS directed to the group of wireless devices (i.e., the STA B 234 and the STA C 236) before exchanging the sequence of data frames. The RTS may also indicate one or more or all wireless devices of the group to reply with a corresponding CTS. Upon receiving the RTS, the indicated wireless devices each may reply a CTS to the STA A 232. The indicated wireless devices may send the CTSs simultaneously or at different time.

In certain configurations, as an example, the STA A 232 may wish to exchange a sequence of data frames with the STA B 234 or the AP 210. The STA A 232 may determine to enable the hidden node protection procedure (e.g., the RTS/CTS procedure) based on a frame type of one or more frames of the sequence of data frames. The STA A 232, the STA B 234, and the AP 210 may be configured with a list of frame types that require the hidden node protection procedure. The frames of those frame types may be considered important and may require protection against hidden node interferences. For example, the STA A 232 may determine that a frame to be transmitted to the STA B 234 is an association request frame or a probe request frame and that the association request frame type or the probe request frame type is included in the list of frame types. Based on the frame type, the STA A 232 may determine that the sequence of data frames need protection against hidden node interferences. Accordingly, in one technique, similarly to the techniques described supra, the STA A 232 may send an RTS directed to the STA B 234, the CTS indicating the transmission time duration T (e.g., through NAV) required to exchange the sequence of data frames. In another technique, similarly to the techniques described supra, the STA A 232 may not send an RTS. Instead, upon receiving a frame of a frame type in the configured list of frame types, the STA B 234 may send a CTS directed to itself, the CTS indicating the transmission time duration T (e.g., through NAV) required to exchange the sequence of data frames.

In certain configurations, as an example, the STA A 232 may wish to exchange one or more frames with the STA B 234 or the AP 210. The STA A 232 may determine to enable the hidden node protection procedure (e.g., the RTS/CTS procedure) based on a retry count for transmitting at least one MSDU in a frame. The STA A 232, the STA B 234, and the AP 210 may be configured with a retry count threshold. For example, the STA A 232 may monitor a retry count for sending each MSDU in the one or more frames to the STA B 234. The retry count may indicate whether the data reception at the STA B 234 is interfered by a hidden node of the STA A 232 (e.g., the STA X 290). If the retry count for sending any particular MSDU in any frame to be exchanged is greater than the retry count threshold, the STA A 232 may use the RTS/CTS procedure as described supra to exchange subsequent frames with the STA B 234.

In certain configurations, as an example, the STA A 232 may wish to exchange one or more frames with the STA B 234 or the AP 210. The STA A 232 may determine to enable the hidden node protection procedure (e.g., the RTS/CTS procedure) based on a relation type of the STA A 232 with respect to the STA B 234 or the AP 210. The STA A 232, the STA B 234, and the AP 210 may be configured with a list of relation types that require a hidden node protection procedure. For example, before sending a frame to the AP 210, the STA A 232 may determine whether the STA A 232 is associated with the AP 210. That is, STA A 232 may determine whether the STA A 232 has an association relation type with respect to the AP 210. If the STA A 232 is associated with the AP 210, the STA A 232 may use the RTS/CTS procedure as described supra to exchange subsequent frames with the AP 210.

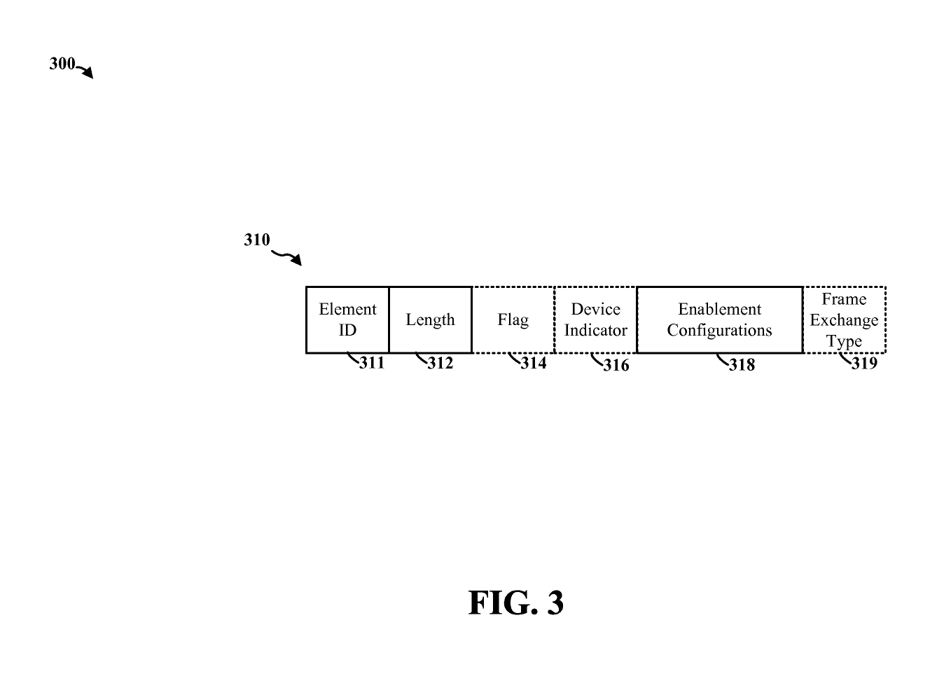

FIG. 3 is a diagram 300 illustrating a format of an exemplary IE used for carrying enablement configurations. An IE 310 includes an element ID field 311, a length field 312, an optional flag field 314, an optional device indicator field 316, an enablement configuration field 318, and an optional frame exchange type field 319. In certain configurations, as an example, the enablement configurations indicating the enabling criterion described supra such as the frame exchanging duration threshold, the list of frame types that require a hidden node protection procedure, the MSDU retry count threshold, the list of relation types that require a hidden node protection procedure may be transmitted from the AP 210 to the STA A 232, STA B 234, STA C 236, and STA X 290. The enablement configurations may be included in the IE 310 of a frame (e.g., a management frame or beacon frame) transmitted from the AP 210. The AP 210 may broadcast, multicast, or unicast to the targeted device(s) the frame having the IE 310.

Specifically, one or more of the configurations may be included in the enablement configuration field 318. Further, the AP 210 may include an identifier (ID) in the element ID field 311 to distinguish the IE having the enablement configurations from other IEs. The AP 210 may include length information indicating the length of remaining fields in the length field 312.

Further, the AP 210 may include a device indicator in the device indicator field 316 to indicate one or more targeted wireless devices of the enablement configurations. If the enablement configurations are directed to a particular wireless device (e.g., the STA A 232), the AP 210 may include a wireless device MAC identifier, a wireless device association identifier, or other identifier that identifies the particular wireless device in the device indicator field 316.

The information in the device indicator field 316 may also indicate the wireless devices that belong to the same group for enabling and disabling the hidden node protection procedure (e.g., the RTS/CTS procedure). If the enablement configurations are directed to a particular group of wireless devices (e.g., the STA B 234 and the STA C 236), the AP 210 may include a group multicast MAC identifier, a group index, or other identifier that identifies the particular group of wireless devices in the device indicator field 316. Further, the AP 210 may include a sequence of bits in the device indicator field 316. Each of the bits is assigned to a particular, respective wireless device associated with the AP. For example, the AP may assign different association IDs to different associated STAs, and the different bits in the sequence correspond to the different association IDs. A predefined value (e.g., 0 or 1) of a given bit may indicate the enablement configurations carried IE 310 is directed to the wireless device to which the given bit is assigned.

Further, the AP 210 may include information in the optional flag field 314 of the IE 310 to indicate whether the device indicator field 316 exists or not. If the device indicator field 316 does not exist, a STA may determine that the enablement configurations carried in the IE 310 are directed to all STAs receiving the IE 310. In addition, the flag and the device indicator field may be included in the IE only when the IE is sent by the AP in a broadcast frame (e.g., a beacon frame).

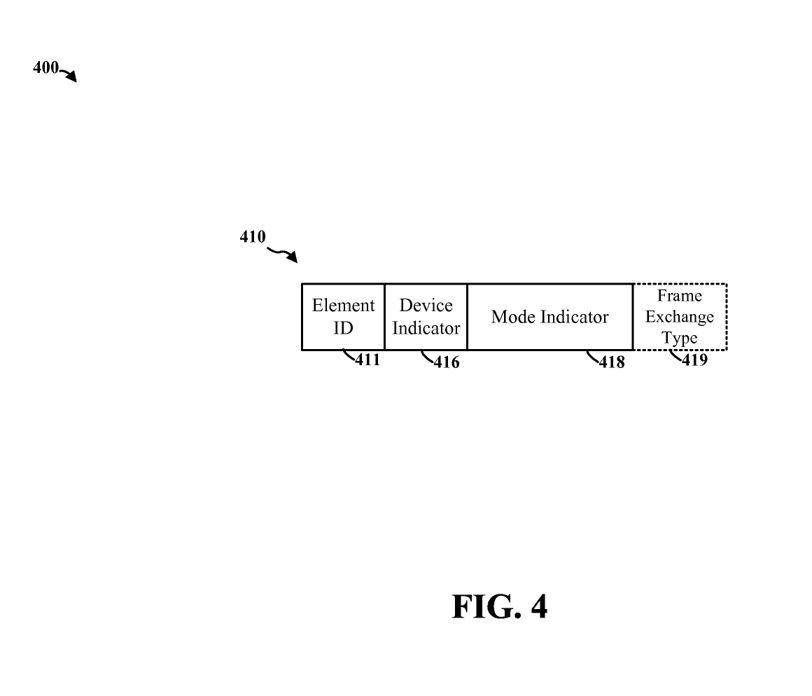

FIG. 4 is a diagram 400 illustrating a format of an exemplary IE used for carrying frame exchange types. An IE 410 includes an element ID field 411, a device indicator field 416, and a mode indicator field 418. The IE 410 may also include an optional frame exchange type field 419. In certain configurations, as an example, a mode indicator may be used to indicate that a targeted wireless device is to use the hidden node protection procedure to initiate any frame exchange. In other words, after receiving such a mode indicator, the targeted wireless device (e.g., the STA A 232) may start using, for example, the RTS/CTS procedure or CTS-to-self procedure in accordance with the enablement configurations. The mode indicator may also be used to indicate that a targeted wireless device is to always not use the hidden node protection procedure to initiate any frame exchange. In other words, after receiving such a mode indicator, the targeted wireless device may stop using, for example, the RTS/CTS procedure or CTS-to-self procedure to exchange frames with another wireless device in accordance with the enablement configurations. The mode indicator may also be used to indicate that a targeted wireless device is to obtain the enablement configurations from an AP for initiating a frame exchange using the hidden node protection procedure. In other words, the targeted wireless device (e.g., the STA A 232) uses the enablement configurations received from an AP (e.g., the AP 210) to determine whether to enable the hidden node protection procedure. The mode indicator may also be used to indicate that a targeted wireless device is to obtain the enablement configurations from the targeted wireless device itself for initiating a frame exchange using the hidden node protection procedure. In other words, the targeted wireless device uses enablement configurations that are preconfigured in the wireless device to determine whether to enable the hidden node protection procedure.

In this example, the mode indicator may be included in the IE 410 of a frame (e.g., a management frame or beacon frame) transmitted from the AP 210. The AP 210 may broadcast, multicast, or unicast to the targeted wireless device the frame having the IE 410.

Specifically, the mode indicator may be included in the mode indicator field 418. Further, the AP 210 may include an ID in the element ID field 411 to distinguish the IE having the mode indicator from other IEs. Further, similarly to what was described supra with respect to the enablement configurations, the AP 210 may include a device indicator in the device indicator field 416 to indicate one or more targeted wireless devices of the mode indicator.

In certain configurations, instead of generating a new IE 410 to carry the mode indicator field 418, the AP 210 may add the mode indicator field 418 to the IE 310. In other words, the enablement configurations and the mode indicator are transmitted together in the same IE 310 and are directed to the wireless devices identified by the device indicator in the device indicator field 316 of the IE 310.

In certain configurations, an AP may provide to a wireless device separate hidden node protection procedure enablement information regarding different frame exchange types such as peer-to-peer transmission and infrastructure transmission. The enablement information may include enablement configurations/enabling criterion, mode indicators, and corresponding group indicators.

For example, the AP may signal RTS enablement information per frame exchange type in different IEs or the same IEs. In either case, a frame exchange type field can be introduced in the IE to associate with corresponding enablement configurations/enabling criteria. The frame exchange type can be peer-to-peer transmission, infrastructure transmission, or both. That is, a wireless device may have different sets of enablement configurations and different mode indicators according to different frame exchange types. For example, the frame exchange types may include at least one of peer-to-peer transmission and infrastructure transmission.

Referring back to FIG. 3, in this example, in one technique, the AP 210 may add the optional frame exchange type field 319 to the IE 310 and may include information indicating a first frame exchange type (e.g., peer-to-peer transmission) to which the enablement configurations in the enablement configuration field 318 is to be applied. A targeted wireless device (e.g., the STA A 232) may, in peer-to-peer transmission, use the enablement configurations included in the IE 310 to determine whether to enable the hidden node protection procedure. For example, when the STA A 232 wishes to initiate a direct communication with the STA B 234 without routing through the AP 210 (i.e., a peer-to-peer transmission), the STA A 232 may use the enablement configurations in the IE 310.

Further, the AP 210 may generate another IE 310 having the optional frame exchange type field 319 and may include information indicating a second frame exchange type (e.g., infrastructure transmission) to which the enablement configurations in the enablement configuration field 318 of the another IE 310 is to be applied. A targeted wireless device (e.g., the STA A 232) may, in infrastructure transmission, use the enablement configurations included in the IE 310 to determine whether to enable the hidden node protection procedure. For example, when the STA A 232 wishes to initiate a communication with the STA B 234 routing through the AP 210 (i.e., an infrastructure transmission), the STA A 232 may use the enablement configurations in the another IE 310.

Similarly, referring back to FIG. 4, in this example, in one technique, the AP 210 may add the optional frame exchange type field 419 to the IE 410 and may include information indicating a frame exchange type (e.g., peer-to-peer transmission or infrastructure transmission) to which the mode indicator in the mode indicator field 418 is to be applied.

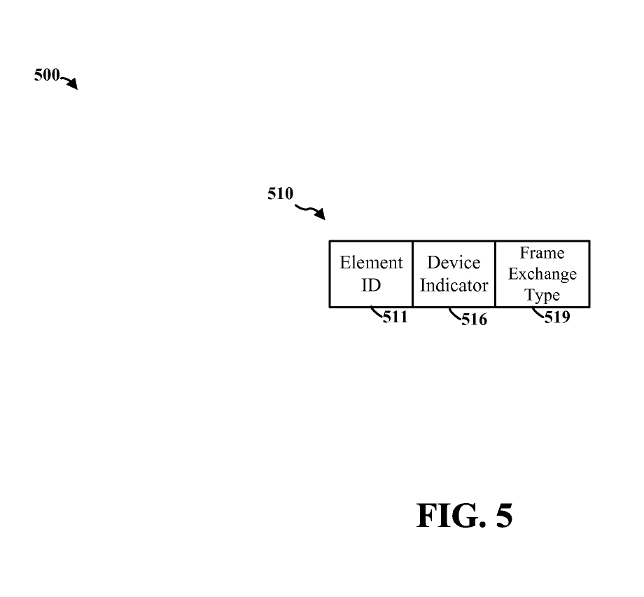

FIG. 5 is a diagram 500 illustrating a format of an exemplary IE used for carrying frame exchange types. An IE 510 includes an element ID field 511, a device indicator field 516, and a frame exchange type field 519. In one technique, as an example, the frame exchange type may be included in the IE 510 of a frame (e.g., a management frame or beacon frame) transmitted from the AP 210. The AP 210 may broadcast, multicast, or unicast to the targeted wireless device the frame having the IE 510.

Specifically, the frame exchange type may be included in the frame exchange type field 519. The AP 210 may include an ID in the element ID field 511. Further, similarly to what was described supra with respect to the enablement configurations, the AP 210 may include a device indicator in the device indicator field 516 to indicate one or more targeted wireless devices of the frame exchange type. Further, the AP 210 may include the element ID(s) of one or more targeted IEs 310 or IEs 410 to which the frame exchange type is to be applied.

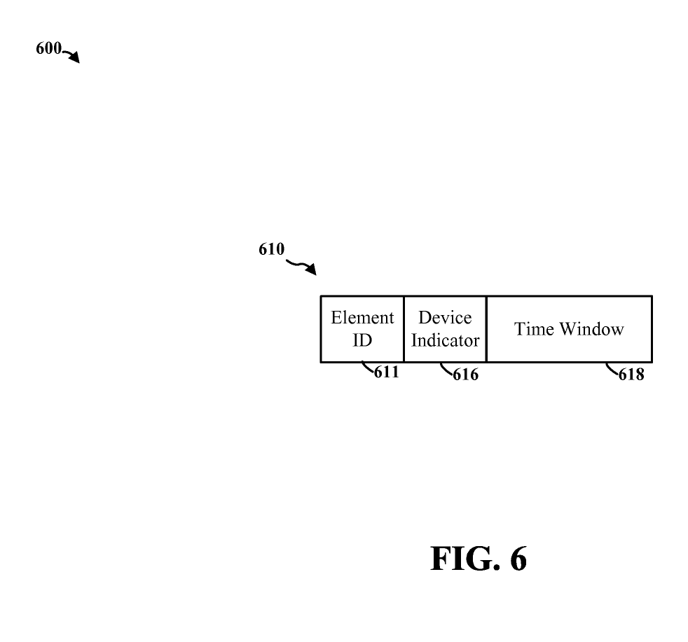

FIG. 6 is a diagram 600 illustrating a format of an exemplary IE used for carrying a time indicator. An IE 610 includes an element ID field 611, a device indicator field 616, and a time window field 618. In certain configurations, the AP may specify one or a sequence of time windows (or time periods) in which the hidden node protection procedure is not to be used. For example, in one of such time windows, all transmissions of the wireless devices associated with the AP may be scheduled by the AP. In another example, in one of such time windows, the AP only schedules downlink transmissions from the AP to the associated devices. Accordingly, there may not be a need to use the hidden node protection procedure during those time periods. The time windows can be specified with the parameters such as a start time, the number of time windows, the duration per time window, the interval between adjacent windows.

As an example, a time indicator indicating the time windows may be included in the IE 610 of a frame (e.g., a management frame or beacon frame) transmitted from the AP 210. The AP 210 may broadcast, multicast, or unicast to the targeted device the frame having the IE 610. Specifically, the time indicator may be included in the time window field 618. The AP 210 may include an ID in the element ID field 611 to distinguish the IE having the time indicator from other IEs. Further, similarly to what was described supra with respect to the enablement configurations, the AP 210 may include a device indicator in the device indicator field 616 to indicate one or more targeted wireless devices of the time indicator. In this example, the STA A 232, upon receiving the IE 610, determines, based on the time indicators in the time window field 618, a time period 270 in which the hidden node protection procedure is not to be enabled. The STA A 232 may wish to initiate a data transmission to the STA B 234 at a time point 272. The STA A 232 further determines that the time point 272 is outside the time period 270. Accordingly, the STA A 232 may further determine whether to enable the hidden node procedure for the data transmission based on the transmission link condition as described supra. Subsequently, the STA A 232 may wish to initiate another data transmission to the STA B 234 at a time point 274. The STA A 232 determines that the time point 274 is within the time period 270. Accordingly, the STA A 232 may initiate this data transmission to the STA B 234 without enabling the hidden node protection procedure.

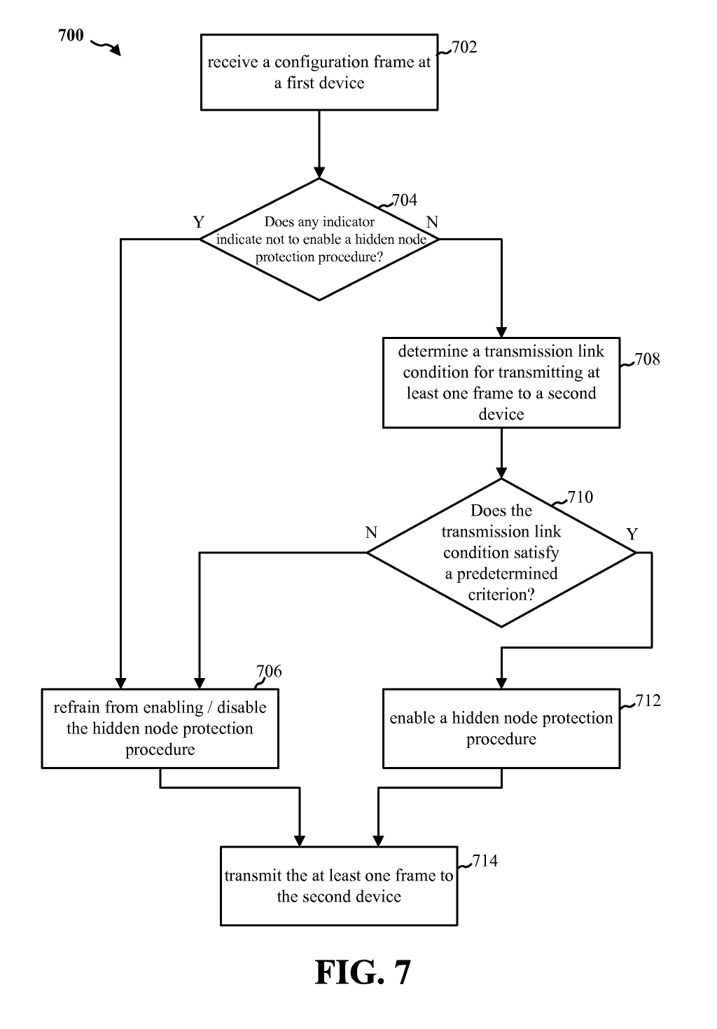

FIG. 7 is a flow chart of an exemplary method 700 for selectively enabling a hidden node protection procedure. The method may be performed by a first device. The first device may be an AP or a STA (e.g., the AP 104, the STA 114, the STA A 232, the apparatus 1302/1202).

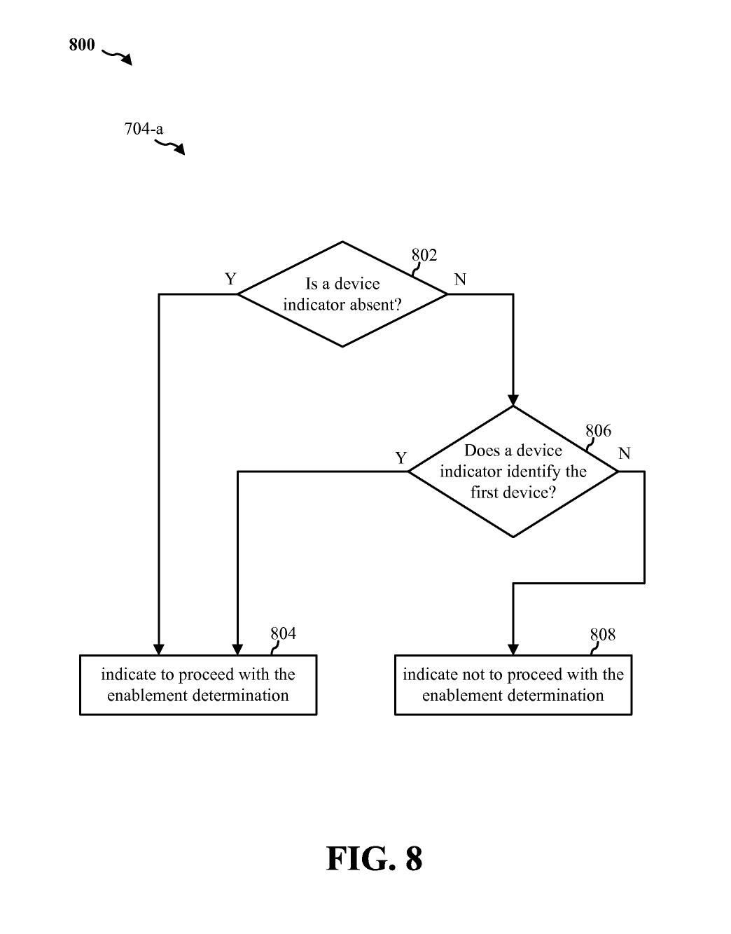

In certain configurations, the first device, at operation 702, receives, from a configuration device, a configuration frame that carries one or more configuration indicators. At operation 704, the first device determines whether any of the configuration indicators indicates not to enable the hidden node protection procedure. More specifically, the first device may perform operations 704-a, 704-b, 704-c, 704-d illustrated in FIGS. 8-11 to receive an indication to proceed with an enablement determination of the hidden node procedure, or an indication not to proceed, from each of operations 704-a, 704-b, 704-c, 704-d. Each of operations 704-a, 704-b, 704-c, 704-d generates the respective indication based on whether a respective configuration indicator received in the configuration frame indicates to the first device not to enable the hidden node protection procedure. When any of the received indications indicates not to proceed with the enablement determination, the first device determines that a configuration indicator indicates not to enable the hidden node protection procedure. Accordingly, the first device, at operation 706, refrains from enabling the hidden node protection procedure or disables the hidden node procedure. Subsequently, the first device enters operation 714.

When each of the received indications indicates to proceed with the enablement determination, the first device determines that none of the configuration indicators indicates not to enable the hidden node protection procedure. Accordingly, the first device, at operation 708, determines a transmission link condition for transmitting at least one frame to a second device. The transmission link condition affects interference received by the second device from a hidden node when the second device is receiving the at least one frame.

At operation 710, the first device determines whether the transmission link condition satisfies a predetermined criterion. When the transmission link condition does not satisfy the predetermined criterion, the first device enters operation 706, refraining from enabling the hidden node protection procedure. Subsequently, the first device enters the operation 714.

When the transmission link condition satisfies the predetermined criterion, the first device, at operation 712, enables the hidden node protection procedure. The hidden node protection procedure reserves a medium used for transmitting the at least one frame to protect reception at the second device from the interference caused by the hidden node. Subsequently, the first device enters the operation 714. At operation 714, the first device transmits the at least one frame to the second device. In certain configurations, the hidden node protection procedure employs a RTS/CTS mechanism or a CTS-to-self mechanism.

In certain configurations, the transmission link condition is a duration allocated for transmitting the at least one frame. The predetermined criterion is a duration threshold. The transmission link condition is determined to satisfy the predetermined criterion when the duration allocated for transmitting the at least one frame is longer than the duration threshold. For example, referring to FIG. 2, the STA A 232 may determine that a transmission time duration T is needed in order to transmit the data frame to the STA B 234. The STA A 232 may have a hidden node STA X 290, which is not a hidden node to the STA B 234. The STA A 232 may be configured with a frame exchange duration threshold. If the transmission time duration T is greater than the frame exchange duration threshold, the STA A 232 may employ a hidden node protection procedure to transmit the data frame to the STAB 234.

In certain configurations, the transmission link condition is a frame type of a first frame of the at least one frame. The predetermined criterion indicates a predetermined frame type, and the transmission link condition is determined to satisfy the predetermined criterion when the frame type of the first frame is the predetermined frame type. In certain configurations, the first frame is an initial frame of a sequence of frames that constitute the at least one frame. For example, referring to FIG. 2, the STA A 232 may wish to exchange a sequence of data frames with the STA B 234 or the AP 210. The STA A 232 may determine to enable the hidden node protection procedure (e.g., the RTS/CTS procedure) based on a frame type of one or more frames of the sequence of data frames. The STA A 232, the STA B 234, and the AP 210 may be configured with a list of frame types that require the hidden node protection procedure. For example, the STA A 232 may determine that a frame to be transmitted to the STA B 234 is an association request frame or a probe request frame, and the association request frame type or the probe request frame type is included in the list of frame types. Based on the frame type, the STA A 232 may determine that the sequence of data frames need protection against hidden node interferences.

In certain configurations, the transmission link condition is a retry count for transmitting a MSDU carried in the at least one frame. The predetermined criterion indicates a retry count threshold, and the transmission link condition is determined to satisfy the predetermined criterion when the retry count of the MSDU is greater than the retry count threshold. For example, referring to FIG. 2, the STA A 232 may determine to enable the hidden node protection procedure (e.g., the RTS/CTS procedure) based on a retry count for transmitting at least one MSDU in a frame. The STA A 232, the STA B 234, and the AP 210 may be configured with a retry count threshold. For example, the STA A 232 may monitor a retry count for sending each MSDU in the one or more frames to the STA B 234. The retry count may indicate whether the data reception at the STA B 234 is interfered by a hidden node of the STA A 232 (e.g., the STA X 290). If the retry count for sending any particular MSDU in any frame to be exchanged is greater than the retry count threshold, the STA A 232 may use the RTS/CTS procedure as described supra to exchange subsequent frames with the STA B 234.

In certain configurations, the transmission link condition is a relation type of the first device with respect to the second device. The predetermined criterion indicates a predetermined relation type, and the transmission link condition is determined to satisfy the predetermined criterion when the relation type of the first device is the predetermined relation type. In certain configurations, the predetermined relation type indicates that the first device is in association with the second device. In certain configurations, the second device is an AP or a peer device of the first device. In certain configurations, the predetermined criterion is carried in an information element (IE) of a frame received from a configuration device. In certain configurations, the configuration device is an access point (AP). For example, referring to FIG. 2, the STA A 232 may determine to enable the hidden node protection procedure (e.g., the RTS/CTS procedure) based on a relation type of the STA A 232 with respect to the STA B 234 or the AP 210. The STA A 232, the STA B 234, and the AP 210 may be configured with a list of relation types that require a hidden node protection procedure. For example, before sending a frame to the AP 210, the STA A 232 may determine whether the STA A 232 is associated with the AP 210. That is, STA A 232 may determine whether the STA A 232 has an association relation type with respect to the AP 210. If the STA A 232 is associated with the AP 210, the STA A 232 may use the RTS/CTS procedure as described supra to exchange subsequent frames with the AP 210.

FIG. 8 is a flow chart of an exemplary method 800 for determining whether to proceed with an enablement determination based on a device indicator. The method may be performed by a first device. The first device may be an AP or a STA (e.g., the AP 104, the STA 114, the STA A 232, the apparatus 1302/1202). Particularly, the method may be operation 704-a performed within operation 704 illustrated in FIG. 7.

In certain configurations, the first device, at operation 802, determines whether a device indicator identifying at least one device to use the predetermined criterion is absent in the configuration frame received in operation 702. When the device indicator is absent, the first device enters operation 804. For example, referring to FIG. 3, the AP 210 may include information in the optional flag field 314 of the IE 310 to indicate whether the device indicator field 316 exists or not. If the device indicator field 316 does not exist, a STA may determine that the enablement configurations carried in the IE 310 are directed to all STAs receiving the IE 310.

When the device indicator is present in the configuration frame, the first device, at operation 806, determines whether the device indicator identifies the first device. When the device indicator identifies the first device, the first device enters operation 804, indicating to proceed with the enablement determination. When the device indicator does not identify the first device, the first device, at operation 808, indicates not to proceed with the enablement determination. For example, referring to FIG. 3, the AP 210 may include a device indicator in the device indicator field 316 of the IE 320 to indicate one or more targeted wireless devices of the enablement configurations. If the enablement configurations are directed to a particular wireless device (e.g., the STA A 232), the AP 210 may include a wireless device MAC identifier, a wireless device association identifier, or other identifier that identifies the particular wireless device in the device indicator field 316.

In certain configurations, the device indicator is at least one of a group multicast MAC identifier, a group index, a device MAC identifier, and a device association identifier. In certain configurations, the device indicator is a sequence of bits. Each of the bits corresponds to a device associated with the configuration device and a predefined value of the each bit indicates that a corresponding device is to use the predetermined criterion.

For example, referring to FIG. 3, when the enablement configurations are directed to a particular group of wireless devices (e.g., the STA B 234 and the STA C 236), the AP 210 may include a group multicast MAC identifier, a group index, or other identifier that identifies the particular group of wireless devices in the device indicator field 316. Further, the AP 210 may include a sequence of bits in the device indicator field 316. Each of the bits is assigned to a particular, respective wireless device associated with the AP. For example, the AP may assign different association IDs to different associated STAs, and the different bits in the sequence correspond to the different association IDs. A predefined value (e.g., 0 or 1) of a given bit may indicate the enablement configurations carried IE 310 is directed to the wireless device to which the given bit is assigned.

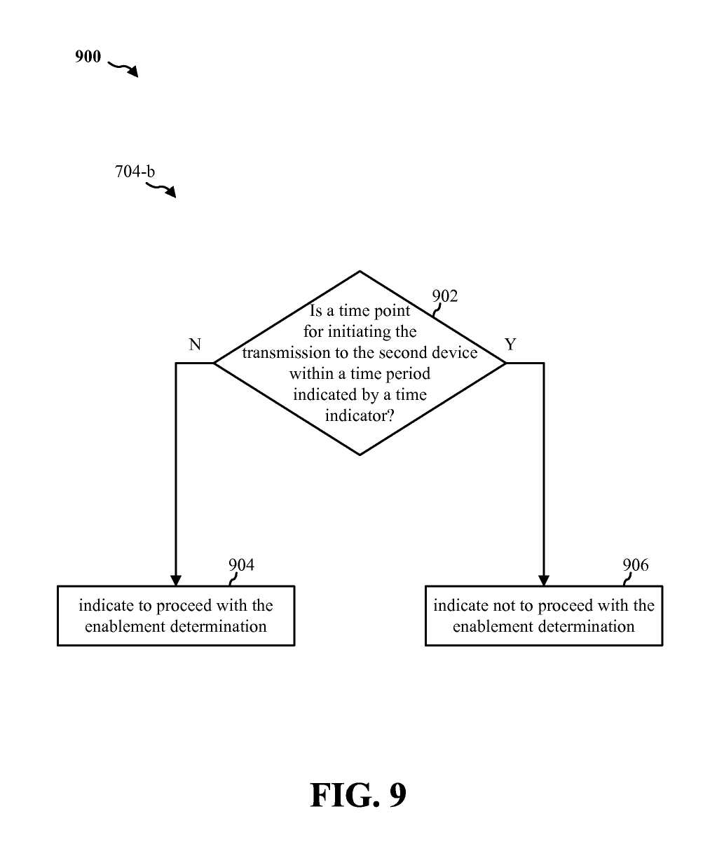

FIG. 9 is a flow chart of an exemplary method 900 for determining whether to proceed with an enablement determination based on a time indicator. The method may be performed by a first device. The first device may be an AP or a STA (e.g., the AP 104, the STA 114, the STA A 232, the apparatus 1302/1202). Particularly, the method may be operation 704-b performed within operation 704 illustrated in FIG. 7.

In certain configurations, the configuration frame may include a time indicator. The time indicator indicates a time period in which the hidden node protection procedure is not to be used. At operation 902, the first device determines whether a time point for initiating the transmission of the at least one frame to the second device is within the time period. When the time point is not within the time period, the first device, at operation 904, indicates to proceed with the enablement determination. When the time point is within the time period, the first device, at operation 906, indicates not to proceed with the enablement determination. For example, referring to FIG. 6, the IE 610 includes, among other fields, a time window field 618. The AP may specify one or a sequence of time windows in which the hidden node protection procedure is not to be used.

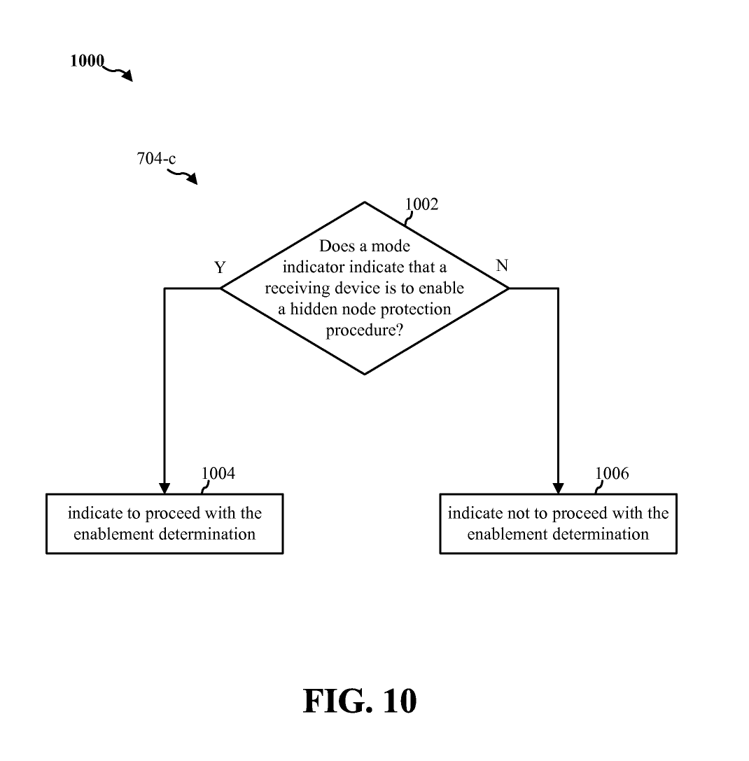

FIG. 10 is a flow chart of an exemplary method 1000 for determining whether to proceed with an enablement determination based on a mode indicator. The method may be performed by a first device. The first device may be an AP or a STA (e.g., the AP 104, the STA 114, the STA A 232, the apparatus 1302/1202). Particularly, the method may be operation 704-c performed within operation 704 illustrated in FIG. 7.

In certain configurations, the configuration frame may include a mode indicator. The mode indicator indicates that a receiving device is to at least one of (a) enable the hidden node protection procedure and (b) not enable the hidden node protection procedure. At operation 1002, the first device determines whether the mode indicator indicates that the receiving device is to enable the hidden node protection procedure. For example, referring to FIG. 4, the IE 410 includes, among other fields, a mode indicator field 418.

When the mode indicator indicates to enable, the first device, at operation 1004, indicates to proceed with the enablement determination. When the mode indicator indicates not to enable, the first device, at operation 1006, indicates not to proceed with the enablement determination. In certain configurations, the mode indicator further indicates that the receiving device is to at least one of (a) obtain the predetermined criterion from the configuration device and (b) obtain the predetermined criterion from the receiving device. The first device obtains the predetermined criterion in accordance with the mode indicator. For example, referring to FIG. 3, the AP 210 may add the mode indicator field 418 to the IE 310. In other words, the enablement configurations and the mode indicator are transmitted together in the same IE 310 and are directed to the wireless devices identified by the device indicator in the device indicator field 316 of the IE 310.

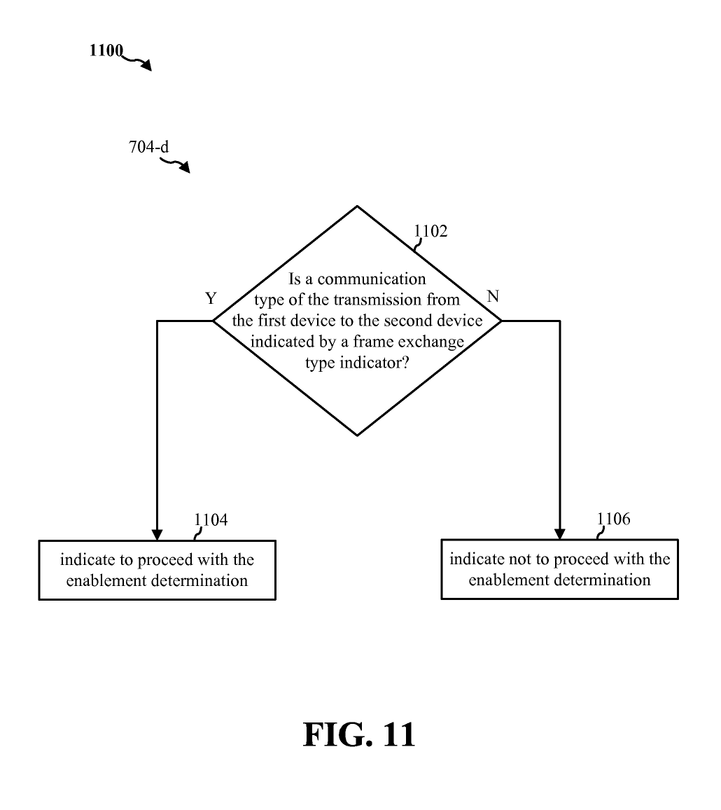

FIG. 11 is a flow chart of an exemplary method 1100 for determining whether to proceed with an enablement determination based on a frame exchange type indicator. The method may be performed by a first device. The first device may be an AP or a STA (e.g., the AP 104, the STA 114, the STA A 232, the apparatus 1302/1202). Particularly, the method may be operation 704-d performed within operation 704 illustrated in FIG. 7. In certain configurations, the configuration frame may include a frame exchange type indicator. The frame exchange type indicator indicates at least one of peer-to-peer communication, infrastructure communication, and mixed peer-to-peer and infrastructure communication At operation 1102, the first device determines whether a frame exchange type of the transmission from the first device to the second device is indicated by the frame exchange type indicator. When the frame exchange type indicator indicates frame exchange type of the transmission from the first device to the second device, the first device, at operation 1104, indicates to proceed with the enablement determination. When the time point does not indicate the frame exchange type of the transmission from the first device to the second device, the first device, at operation 1106, indicates not to proceed with the enablement determination. For example, referring to FIG. 5, the IE 510 includes, among other fields, a frame exchange type field 519. For example, referring to FIG. 3, the AP 210 may generate an IE 310 having the optional frame exchange type field 319 and may include information indicating a second frame exchange type (e.g., infrastructure transmission) to which the enablement configurations in the enablement configuration field 318 of the another IE 310 is to be applied.

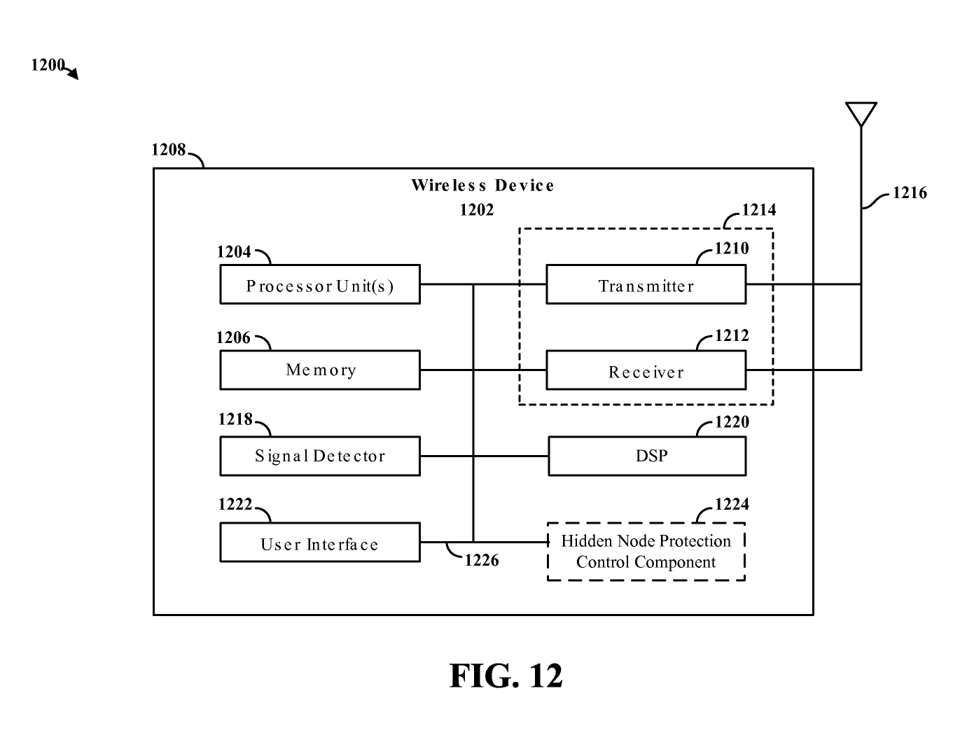

FIG. 12 shows an example functional block diagram of a wireless device 1202 that may be employed within the wireless communication system 100 of FIG. 1 or the wireless network of FIG. 2. The wireless device 1202 is an example of a device that may be configured to implement the various methods described herein. For example, the wireless device 1202 may comprise one of the APs 104 and 210 or one of the STAs 114, 232, 234, 236, and 290.

The wireless device 1202 may include a processor 1204 which controls operation of the wireless device 1202. The processor 1204 may also be referred to as a central processing unit (CPU). Memory 1206, which may include both read-only memory (ROM) and random access memory (RAM), may provide instructions and data to the processor 1204. A portion of the memory 1206 may also include non-volatile random access memory (NVRAM). The processor 1204 typically performs logical and arithmetic operations based on program instructions stored within the memory 1206. The instructions in the memory 1206 may be executable (by the processor 1204, for example) to implement the methods described herein.

The processor 1204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 1202 may also include a housing 1208 that may include a transmitter 1210 and/or a receiver 1212 to allow transmission and reception of data between the wireless device 1202 and a remote device. The transmitter 1210 and the receiver 1212 may be combined into a transceiver 1214. An antenna 1216 may be attached to the housing 1208 and electrically coupled to the transceiver 1214. The wireless device 1202 may also include (not shown) multiple transmitters, multiple receivers, multiple transceivers, and/or multiple antennas.

The wireless device 1202 may also include a signal detector 1218 that may be used to detect and quantify the level of signals received by the transceiver 1214 or the receiver 1212. The signal detector 1218 may detect such signals as total energy, energy per subcarrier per symbol, power spectral density, and other signals. The wireless device 1202 may also include a digital signal processor (DSP) 1220 for use in processing signals. The DSP 1220 may be configured to generate a packet for transmission. In some aspects, the packet may comprise a physical layer data unit (PPDU).

The wireless device 1202 may further comprise a user interface 1222 in some aspects. The user interface 1222 may comprise a keypad, a microphone, a speaker, and/or a display. The user interface 1222 may include any element or component that conveys information to a user of the wireless device 1202 and/or receives input from the user.

The wireless device 1202 may also comprise a hidden node protection control component 1224. The wireless device 1202 may be referred to as a first wireless device. The wireless device 1202 may be implemented as an AP or a STA.

Further, the hidden node protection control component 1224 may control a process of determining a transmission link condition for transmitting at least one frame to a second device, the transmission link condition affecting interference received by the second device from a hidden node when the second device is receiving the at least one frame. The hidden node protection control component 1224 may control a process of determining whether the transmission link condition satisfies a predetermined criterion. The hidden node protection control component 1224 may control a process of enabling a hidden node protection procedure when the transmission link condition satisfy the predetermined criterion, the hidden node protection procedure reserving a medium used for transmitting the at least one frame to protect reception at the second device from the interference caused by the hidden node. The hidden node protection control component 1224 may control a process of transmitting the at least one frame to the second device.

The various components of the wireless device 1202 may be coupled together by a bus system 1226. The bus system 1226 may include a data bus, for example, as well as a power bus, a control signal bus, and a status signal bus in addition to the data bus. Components of the wireless device 1202 may be coupled together or accept or provide inputs to each other using some other mechanism.

Although a number of separate components are illustrated in FIG. 12, one or more of the components may be combined or commonly implemented. For example, the processor 1204 may be used to implement not only the functionality described above with respect to the processor 1204, but also to implement the functionality described above with respect to the signal detector 1218, the DSP 1220, the user interface 1222, and/or the hidden node protection control component 1224. Further, each of the components illustrated in FIG. 12 may be implemented using a plurality of separate elements.

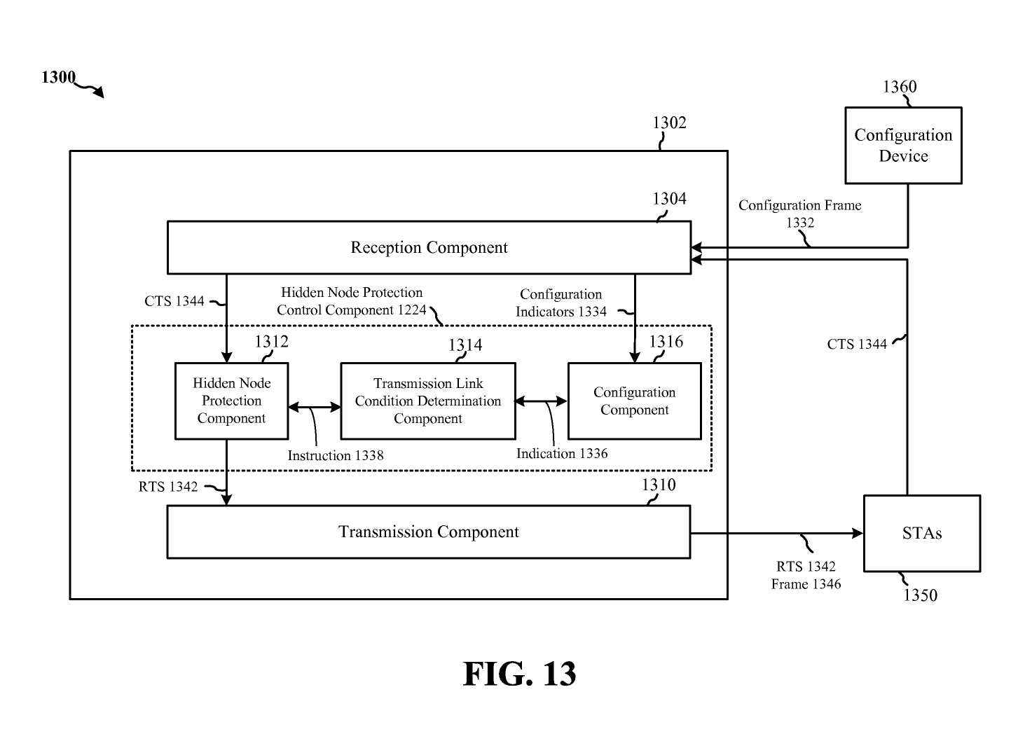

FIG. 13 is a conceptual data flow diagram 1300 illustrating the data flow between different components/means in an exemplary apparatus 1302. The apparatus 1302 may be an AP or a STA (e.g., the AP 104, the STA 114, the STA A 232). The apparatus 1302 includes a reception component 1304, a transmission component 1310, a hidden node protection component 1312, a transmission link condition determination component 1314, and a configuration component 1316.

The reception component 1304 may receive, from a configuration device 1360, a configuration frame 1332 that carries one or more configuration indicators 1334. The reception component 1304 sends the one or more configuration indicators 1334 to the configuration component 1316. The configuration component 1316 determines whether a device indicator identifying at least one device to use a predetermined criterion is absent from the one or more configuration indicators 1334. When the device indicator is absent, the configuration component 1316 may send, to the transmission link condition determination component 1314, an indication 1336 indicating to proceed with an enablement determination of a hidden node protection procedure.

When the device indicator is present in the one or more configuration indicators 1334, the configuration component 1316 further determines whether the device indicator identifies the apparatus 1302. When the device indicator identifies the apparatus 1302, the configuration component 1316 may send, to the transmission link condition determination component 1314, an indication 1336 indicating to proceed with an enablement determination. When the device indicator does not identify the apparatus 1302, the configuration component 1316 may send, to the transmission link condition determination component 1314, an indication 1336 indicating not to proceed with the enablement determination.

In certain configurations, the device indicator is at least one of a group multicast MAC identifier, a group index, a device MAC identifier, and a device association identifier. In certain configurations, the device indicator is a sequence of bits. Each of the bits corresponds to a device associated with the configuration device 1360 and a predefined value of the each bit indicates that a corresponding device is to use the predetermined criterion.

In certain configurations, the one or more configuration indicators 1334 may include a time indicator. The time indicator indicates a time period in which the hidden node protection procedure is not to be used. The configuration component 1316 may determine whether a time point for initiating transmission of at least one frame 1346 to a second device 1350 is within the time period. When the time point is not within the time period, the configuration component 1316 may send, to the transmission link condition determination component 1314, an indication 1336 indicating to proceed with an enablement determination. When the time point is within the time period, the configuration component 1316 may send, to the transmission link condition determination component 1314, an indication 1336 indicating not to proceed with the enablement determination.

In certain configurations, the one or more configuration indicators 1334 may include a mode indicator. The mode indicator indicates that a receiving device is to at least one of (a) enable the hidden node protection procedure and (b) not enable the hidden node protection procedure. The configuration component 1316 determines whether the mode indicator indicates that the receiving device is to enable the hidden node protection procedure. When the mode indicator indicates to enable, the configuration component 1316 may send, to the transmission link condition determination component 1314, an indication 1336 indicating to proceed with an enablement determination. When the mode indicator indicates not to enable, the configuration component 1316 may send, to the transmission link condition determination component 1314, an indication 1336 indicating not to proceed with the enablement determination.

In certain configurations, the mode indicator further indicates that the receiving device is to at least one of (a) obtain the predetermined criterion from the configuration device 1360 and (b) obtain the predetermined criterion from the receiving device. The configuration component 1316 send, to the transmission link condition determination component 1314, an indication 1336 indicating where to obtain the predetermined criterion accordingly. The transmission link condition determination component 1314 may obtain the predetermined criterion accordingly.

In certain configurations, the one or more configuration indicators 1334 may include a frame exchange type indicator. The frame exchange type indicator indicates at least one of peer-to-peer communication, infrastructure communication, and mixed peer-to-peer and infrastructure communication. The configuration component 1316 determines whether a frame exchange type of the transmission from the first device to the second device is indicated by the frame exchange type indicator. When the frame exchange type indicator indicates frame exchange type of the transmission from the first device to the second device, the configuration component 1316 may send, to the transmission link condition determination component 1314, an indication 1336 indicating to proceed with an enablement determination. When the time point does not indicate the frame exchange type of the transmission from the first device to the second device, the configuration component 1316 may send, to the transmission link condition determination component 1314, an indication 1336 indicating not to proceed with the enablement determination.

The transmission link condition determination component 1314 may be configured to determine whether to proceed with the enablement determination of a hidden node protection procedure. More specifically, the transmission link condition determination component 1314 may determine whether to proceed based on the indications 1336 received from configuration component 1316. When any of the received indications indicates not to proceed with the enablement determination, the transmission link condition determination component 1314 may send an instruction 1338 to the hidden node protection component 1312. The instruction 1338 instruct the hidden node protection component 1312 to refrain from enabling the hidden node protection procedure.

When each of the received indications indicates to proceed with the enablement determination, the transmission link condition determination component 1314 may further determine a transmission link condition for transmitting the at least one frame 1346 to the second device 1350. The transmission link condition affects interference received by the second device 1350 from a hidden node when the second device is receiving the at least one frame 1346 from the apparatus 1302.

The transmission link condition determination component 1314 determines whether the transmission link condition satisfies a predetermined criterion. When the transmission link condition does not satisfy the predetermined criterion, the transmission link condition determination component 1314 may send an instruction 1338 to the hidden node protection component 1312. The instruction 1338 instruct the hidden node protection component 1312 to refrain from enabling the hidden node protection procedure.

When the transmission link condition satisfies the predetermined criterion, the transmission link condition determination component 1314 may send an instruction 1338 to the hidden node protection component 1312. The instruction 1338 instruct the hidden node protection component 1312 to enable the hidden node protection procedure. The hidden node protection procedure reserves a medium used for transmitting the at least one frame 1346 to protect reception at the second device 1350 from the interference caused by the hidden node.

Accordingly, the hidden node protection component 1312 may enable the hidden node protection procedure for transmitting the at least one frame 1346 to the second device 1350. In certain configurations, the hidden node protection procedure employs a RTS/CTS mechanism or a CTS-to-self mechanism. More particularly, the hidden node protection component 1312 may construct an RTS 1342 and send the RTS 1342 to the transmission component 1310. The hidden node protection component 1312 may instruct the transmission component 1310 to transmit the RTS 1342 to the second device 1350 prior to transmitting the at least one frame 1346. Subsequently, the transmission component 1310 transmits the RTS 1342 to the second device 1350. The reception component 1304 may receive a CTS 1344 from the second device 1350. The reception component 1304 sends the CTS 1344 to the hidden node protection component 1312. Upon receiving the CTS 1344, the transmission component 1310 may send the at least one frame 1346 to the second device 1350. When the hidden node protection procedure is not enabled, the transmission component 1310 transmits the at least one frame 1346 to the second device 1350 without transmitting an RTS or CTS.

In certain configurations, the transmission link condition is a duration allocated for transmitting the at least one frame. The predetermined criterion is a duration threshold. The transmission link condition is determined to satisfy the predetermined criterion when the duration allocated for transmitting the at least one frame is longer than the duration threshold. In certain configurations, the transmission link condition is a frame type of a first frame of the at least one frame 1346. The predetermined criterion indicates a predetermined frame type, and the transmission link condition is determined to satisfy the predetermined criterion when the frame type of the first frame is the predetermined frame type. In certain configurations, the first frame is an initial frame of a sequence of frames that constitute the at least one frame 1346. In certain configurations, the transmission link condition is a retry count for transmitting a medium access control (MAC) service data unit (MSDU) carried in the at least one frame 1346. The predetermined criterion indicates a retry count threshold, and the transmission link condition is determined to satisfy the predetermined criterion when the retry count of the MSDU is greater than the retry count threshold. In certain configurations, the transmission link condition is a relation type of the apparatus 1302 with respect to the second device 1350. The predetermined criterion indicates a predetermined relation type, and the transmission link condition is determined to satisfy the predetermined criterion when the relation type of the apparatus 1302 is the predetermined relation type. In certain configurations, the predetermined relation type indicates that the apparatus 1302 is in association with the second device 1350. In certain configurations, the second device 1350 is an AP or a peer device of the apparatus 1302. In certain configurations, the predetermined criterion is carried in an IE of a frame received from a configuration device 1360. In certain configurations, the configuration device 1360 is an AP.

The apparatus may include additional components that perform each of the blocks of the algorithm in the aforementioned flowcharts of FIGS. 7-11. As such, each block in the aforementioned flowcharts of FIGS. 7-11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The hidden node protection component 1312, the transmission link condition determination component 1314, and the configuration component 1316 may constitute the hidden node protection control component 1224 shown in FIG. 12. The hidden node protection component 1312, the transmission link condition determination component 1314, and the configuration component 1316 may employ the processor 1204, the memory 1206, the signal detector 1218, the DSP 1220, and/or the user interface 1222. The reception component 1304 and the transmission component 1310 may employ the processor 1204, the memory 1206, the signal detector 1218, and/or the DSP 1220. The transceiver 1214 receives a signal from the one or more antennas 1216, extracts information from the received signal, and provides the extracted information to the reception component 1304. In addition, the transceiver 1214 receives information from the transmission component 1310, and based on the received information, generates a signal to be applied to the one or more antennas 1216.

In one aspect, the apparatus 1302/1202 may be an AP. The apparatus 1302/1202 may be configured to include means for performing the operations illustrated in FIGS. 7-11. More specifically, the apparatus 1302/1202 may be configured to include means for determining a transmission link condition for transmitting at least one frame to a second device, the transmission link condition affecting interference received by the second device from a hidden node when the second device is receiving the at least one frame. The apparatus 1302/1202 may be configured to include means for determining whether the transmission link condition satisfies a predetermined criterion. The apparatus 1302/1202 may be configured to include means for enabling a hidden node protection procedure when the transmission link condition satisfy the predetermined criterion, the hidden node protection procedure reserving a medium used for transmitting the at least one frame to protect reception at the second device from the interference caused by the hidden node. The apparatus 1302/1202 may be configured to include means for transmitting the at least one frame to the second device. In certain configurations, the hidden node protection procedure employs an RTS/CTS mechanism or a CTS-to-self mechanism.

In certain configurations, the transmission link condition is a duration allocated for transmitting the at least one frame. The predetermined criterion is a duration threshold. The transmission link condition is determined to satisfy the predetermined criterion when the duration allocated for transmitting the at least one frame is longer than the duration threshold. In certain configurations, the transmission link condition is a frame type of a first frame of the at least one frame. The predetermined criterion indicates a predetermined frame type, and the transmission link condition is determined to satisfy the predetermined criterion when the frame type of the first frame is the predetermined frame type. In certain configurations, the first frame is an initial frame of a sequence of frames that constitute the at least one frame.

In certain configurations, the transmission link condition is a retry count for transmitting a medium access control (MAC) service data unit (MSDU) carried in the at least one frame. The predetermined criterion indicates a retry count threshold, and the transmission link condition is determined to satisfy the predetermined criterion when the retry count of the MSDU is greater than the retry count threshold.

In certain configurations, the transmission link condition is a relation type of the first device with respect to the second device. The predetermined criterion indicates a predetermined relation type, and the transmission link condition is determined to satisfy the predetermined criterion when the relation type of the first device is the predetermined relation type. In certain configurations, the predetermined relation type indicates that the first device is in association with the second device.

In certain configurations, the second device is an AP or a peer device of the first device. In certain configurations, the apparatus 1302/1202 may be configured to include means for receiving the predetermined criterion in an IE of a frame from a configuration device. In certain configurations, the configuration device is an access point (AP).

In certain configurations, the apparatus 1302/1202 may be configured to include means for determining that a device indicator identifying at least one device to use the predetermined criterion is absent in the frame, and the determining whether the transmission link condition satisfies the predetermined criterion is performed in response to the determination that the device indicator is absent. In certain configurations, the apparatus 1302/1202 may be configured to include means for receiving a device indicator in a frame from a configuration device. The device indicator indicates at least one device to use the predetermined criterion. The apparatus 1302/1202 may be configured to include means for determining that the device indicator identifies the first device, and the determining whether the transmission link condition satisfies the predetermined criterion is performed in response to the determination that the device indicator identifies the first device.

In certain configurations, the device indicator is at least one of a group multicast MAC identifier, a group index, a device MAC identifier, and a device association identifier. In certain configurations, the device indicator is a sequence of bits. Each of the bits corresponds to a device associated with the configuration device and a predefined value of the each bit indicates that a corresponding device is to use the predetermined criterion.

In certain configurations, the apparatus 1302/1202 may be configured to include means for receiving a time indicator in a frame from a configuration device. The time indicator indicates a time period in which the hidden node protection procedure is not to be used. The apparatus 1302/1202 may be configured to include means for determining that a time point for initiating the transmission of the at least one frame to the second device is not within the time period. The transmission of the at least one frame to the second device is initiated at the time point.

In certain configurations, the apparatus 1302/1202 may be configured to include means for receiving a mode indicator in a frame from a configuration device. The mode indicator indicates that a receiving device is to at least one of (a) enable the hidden node protection procedure and (b) not enable the hidden node protection procedure. The determining whether the transmission link condition satisfies the predetermined criterion is performed when the mode indicator indicates that the receiving device is to enable the hidden node protection procedure. In certain configurations, the mode indicator further indicates that the receiving device is to at least one of (a) obtain the predetermined criterion from the configuration device and (b) obtain the predetermined criterion from the receiving device. The apparatus 1302/1202 may be configured to include means for obtaining the predetermined criterion in accordance with the mode indicator.

In certain configurations, the apparatus 1302/1202 may be configured to include means for receiving a frame exchange type indicator in a frame from a configuration device. The frame exchange type indicator indicates at least one of peer-to-peer communication, infrastructure communication, and mixed peer-to-peer and infrastructure communication. The apparatus 1302/1202 may be configured to include means for determining that a frame exchange type of the transmission from the first device to the second device is indicated by the frame exchange type indicator. The determining whether the transmission link condition satisfies the predetermined criterion is performed in response to the determination that the frame exchange type of the transmission from the first device to the second device is indicated by the frame exchange type indicator.

The aforementioned means may be one or more of the aforementioned components of the apparatus 1302/1202 configured to perform the functions recited by the aforementioned means. The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that components, components, and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication of a first device, the first device being an access point (AP) or a station (STA), comprising:
determining a transmission link condition for transmitting at least one frame to a second device, the transmission link condition affecting interference received by the second device from a hidden node when the second device is receiving the at least one frame;
determining whether the transmission link condition satisfies a predetermined criterion;
enabling a hidden node protection procedure when the transmission link condition satisfy the predetermined criterion, the hidden node protection procedure reserving a medium used for transmitting the at least one frame to protect reception at the second device from the interference caused by the hidden node; and
transmitting the at least one frame to the second device.

2. The method of claim 1, wherein the hidden node protection procedure employs a Request-to-Send (RTS)/Clear-to-Send (CTS) mechanism or a CTS-to-self mechanism.

3. The method of claim 1, wherein the transmission link condition is a duration allocated for transmitting the at least one frame, wherein the predetermined criterion is a duration threshold, wherein the transmission link condition is determined to satisfy the predetermined criterion when the duration allocated for transmitting the at least one frame is longer than the duration threshold.

4. The method of claim 1, wherein the transmission link condition is a frame type of a first frame of the at least one frame, wherein the predetermined criterion indicates a predetermined frame type, and wherein the transmission link condition is determined to satisfy the predetermined criterion when the frame type of the first frame is the predetermined frame type.

5. The method of claim 4, wherein the first frame is an initial frame of a sequence of frames that constitute the at least one frame.

6. The method of claim 1, wherein the transmission link condition is a retry count for transmitting a medium access control (MAC) service data unit (MSDU) carried in the at least one frame, wherein the predetermined criterion indicates a retry count threshold, and wherein the transmission link condition is determined to satisfy the predetermined criterion when the retry count of the MSDU is greater than the retry count threshold.

7. The method of claim 1, wherein the transmission link condition is a relation type of the first device with respect to the second device, wherein the predetermined criterion indicates a predetermined relation type, and wherein the transmission link condition is determined to satisfy the predetermined criterion when the relation type of the first device is the predetermined relation type.

8. The method of claim 7, wherein the predetermined relation type indicates that the first device is in association with the second device.

9. The method of claim 1, wherein the second device is an access point (AP) or a peer device of the first device.

10. The method of claim 1, further comprising receiving the predetermined criterion in an information element (IE) of a frame from a configuration device.

11. The method of claim 10, wherein the configuration device is an access point (AP).

12. The method of claim 10, further comprising determining that a device indicator identifying at least one device to use the predetermined criterion is absent in the frame, wherein the determining whether the transmission link condition satisfies the predetermined criterion is performed in response to the determination that the device indicator is absent.

13. The method of claim 1, further comprising:
receiving a device indicator in a frame from a configuration device, wherein the device indicator indicates at least one device to use the predetermined criterion; and
determining that the device indicator identifies the first device, wherein the determining whether the transmission link condition satisfies the predetermined criterion is performed in response to the determination that the device indicator identifies the first device.

14. The method of claim 13, wherein the device indicator is at least one of a group multicast medium access control (MAC) identifier, a group index, a device MAC identifier, and a device association identifier.

15. The method of claim 13, wherein the device indicator is a sequence of bits, wherein each bit of the bits corresponds to a device associated with the configuration device and a predefined value of the each bit indicates that a corresponding device is to use the predetermined criterion.

16. The method of claim 1, further comprising:
receiving a time indicator in a frame from a configuration device, wherein the time indicator indicates a time period in which the hidden node protection procedure is not to be used; and
determining that a time point for initiating the transmission of the at least one frame to the second device is not within the time period, wherein the transmission of the at least one frame to the second device is initiated at the time point.

17. The method of claim 1, further comprising:
receiving a mode indicator in a frame from a configuration device, wherein the mode indicator indicates that a receiving device is to at least one of:
enable the hidden node protection procedure, and
not enable the hidden node protection procedure;
wherein the determining whether the transmission link condition satisfies the predetermined criterion is performed when the mode indicator indicates that the receiving device is to enable the hidden node protection procedure.

18. The method of claim 17, wherein the mode indicator further indicates that the receiving device is to at least one of:
obtain the predetermined criterion from the configuration device, and
obtain the predetermined criterion from the receiving device;
the method further comprising obtaining the predetermined criterion in accordance with the mode indicator.

19. The method of claim 1, further comprising:
receiving a frame exchange type indicator in a frame from a configuration device, wherein the frame exchange type indicator indicates at least one of peer-to-peer communication, infrastructure communication, and mixed peer-to-peer and infrastructure communication; and
determining that a frame exchange type of the transmission from the first device to the second device is indicated by the frame exchange type indicator, wherein the determining whether the transmission link condition satisfies the predetermined criterion is performed in response to the determination that the frame exchange type of the transmission from the first device to the second device is indicated by the frame exchange type indicator.

20. An apparatus for wireless communication, the apparatus being a first device, comprising:
a memory; and
at least one processor coupled to the memory and configured to:
determine a transmission link condition for transmitting at least one frame to a second device, the transmission link condition affecting interference received by the second device from a hidden node when the second device is receiving the at least one frame;
determine whether the transmission link condition satisfies a predetermined criterion;
enable a hidden node protection procedure when the transmission link condition satisfy the predetermined criterion, the hidden node protection procedure reserving a medium used for transmitting the at least one frame to protect reception at the second device from the interference caused by the hidden node; and
transmit the at least one frame to the second device.

21. The apparatus of claim 20, wherein the hidden node protection procedure employs a Request-to-Send (RTS)/Clear-to-Send (CTS) mechanism or a CTS-to-self mechanism.

22. The apparatus of claim 20, wherein the transmission link condition is a duration allocated for transmitting the at least one frame, wherein the predetermined criterion is a duration threshold, wherein the transmission link condition is determined to satisfy the predetermined criterion when the duration allocated for transmitting the at least one frame is longer than the duration threshold.

23. The apparatus of claim 20, wherein the transmission link condition is a frame type of a first frame of the at least one frame, wherein the predetermined criterion indicates a predetermined frame type, and wherein the transmission link condition is determined to satisfy the predetermined criterion when the frame type of the first frame is the predetermined frame type.

24. The apparatus of claim 23, wherein the first frame is an initial frame of a sequence of frames that constitute the at least one frame.

25. The apparatus of claim 20, wherein the transmission link condition is a retry count for transmitting a medium access control (MAC) service data unit (MSDU) carried in the at least one frame, wherein the predetermined criterion indicates a retry count threshold, and wherein the transmission link condition is determined to satisfy the predetermined criterion when the retry count of the MSDU is greater than the retry count threshold.

26. The apparatus of claim 20, wherein the transmission link condition is a relation type of the first device with respect to the second device, wherein the predetermined criterion indicates a predetermined relation type, and wherein the transmission link condition is determined to satisfy the predetermined criterion when the relation type of the first device is the predetermined relation type.

27. The apparatus of claim 26, wherein the predetermined relation type indicates that the first device is in association with the second device.

28. The apparatus of claim 20, wherein the second device is an access point (AP) or a peer device of the first device.

29. An apparatus for wireless communication, the apparatus being a first device, comprising:
means for determining a transmission link condition for transmitting at least one frame to a second device, the transmission link condition affecting interference received by the second device from a hidden node when the second device is receiving the at least one frame;
means for determining whether the transmission link condition satisfies a predetermined criterion;
means for enabling a hidden node protection procedure when the transmission link condition satisfy the predetermined criterion, the hidden node protection procedure reserving a medium used for transmitting the at least one frame to protect reception at the second device from the interference caused by the hidden node; and
means for transmitting the at least one frame to the second device.

30. A computer-readable medium storing computer executable code for wireless communication at a first device, the first device being an access point (AP) or a station (STA), comprising code for:
determining a transmission link condition for transmitting at least one frame to a second device, the transmission link condition affecting interference received by the second device from a hidden node when the second device is receiving the at least one frame;
determining whether the transmission link condition satisfies a predetermined criterion;
enabling a hidden node protection procedure when the transmission link condition satisfy the predetermined criterion, the hidden node protection procedure reserving a medium used for transmitting the at least one frame to protect reception at the second device from the interference caused by the hidden node; and
transmitting the at least one frame to the second device.
